(19) United States
(12) Patent Application Publication
(10) Pub. No.: US 2011/0081213 A1
(43) Pub. Date: Apr. 7, 2011

(54) Cutting Insert and Method of Manufacture Thereof

(75) Inventor: Assaf Ballas, Akko (IL)

(73) Assignee: Iscar, Ltd., Tefen (IL)

(21) Appl. No.: 12/871,357

(22) Filed: Aug. 30, 2010

(30) Foreign Application Priority Data
Oct. 1, 2009 (IL) 201272

(51) Int. Cl. B23B 27/16; B23P 15/28; B23C 5/20

(52) U.S. Cl. 407/113; 451/28; 76/101.1

(57) ABSTRACT

A cutting insert and a method for manufacturing a cutting insert has a peripheral surface extending between a top surface and a bottom surface, the peripheral surface including a corner surface extending between a first side surface and a second side surface. At least one of the first and second side surfaces is substantially planar and the corner surface has at least a substantial curved unground portion. The corner surface is a residual portion of a blank corner surface of an insert blank which remains intact following grinding of at least one of the first and second side surfaces.

### FIELD OF THE INVENTION

The present invention relates to a cutting insert and to a method of manufacture thereof, the cutting insert having one or more corner surfaces which are obtained without grinding.

### BACKGROUND OF THE INVENTION

Many indexable cutting inserts used for milling, turning, or other metal cutting operations include a top surface, a bottom surface, and a peripheral surface extending therebetween. The peripheral surface includes, for example, a plurality of side surfaces that may function as clearance surfaces and/or as engagement surfaces for engaging an insert pocket having the cutting insert retained therein. The peripheral surface additionally includes one or more corner surfaces e.g., curved or partially curved corner surfaces that extend between the respective adjacent side surfaces, and function, for example, as clearance surfaces and/or as engagement surfaces.

In many instances manufacturing a cutting insert includes an initial step of manufacturing an insert blank, for example, using pressing and sintering or injection molding techniques. In following steps, different edges and surfaces of the insert blank are ground to obtain therefrom respective surfaces of the cutting insert.

As an illustrative example, FIGS. 1-2, which are briefly described below, show a plurality of steps of manufacturing a cutting insert 122 according to the prior art. As shown, for example, in FIG. 1, an insert blank 120 is initially formed, having a blank first side surface 148, a blank second side surface 150 and a curved blank corner surface 140 extending therebetween. The curved blank corner surface 140 may have a typical radius of curvature T. Manufacture of the cutting insert 122 according to the prior art may include planar grinding the blank first and second side surfaces 148 and 150, to respectively obtain therefrom first and second side surfaces 130 and 132 of the cutting insert 122. The typical magnitude of the radius of curvature T may result in that the grinding applied to the blank first and second side surfaces 148 and 150 reduces the curved blank corner surface 140 to a corner edge 152.

As shown, for example, in FIG. 2, in a following step corner grinding is applied to the corner edge 152 and its surroundings to form a curved corner surface 134 extending between the first and second side surfaces 130 and 132. The curved corner surface 134 may be required to assume a curved shape, for example, in order to comply with different functionality requirements of the cutting insert 122, for example, clearance or engagement requirements.

In many instances, one or both of the first and second side surfaces 130 and 132 are generally planar, and thus formed with relative ease. For example, each of the first and second side surfaces 130 and 132 may conveniently be formed by applying a single, short planar grinding stroke to the respective blank side surfaces 148 and 150 of the insert blank 120. On the other hand, due to the curved shape requirements thereof, the curved corner surface 134 according to the prior art may only be obtained through extensive, multi-stroke grinding of the corner edge 152. Therefore, the time required for forming the curved corner surface 134 may be, for example, five times higher than the time required for forming each of the first and second side surfaces 148 and 150. Accordingly, manufacture of the cutting insert 122 may be unnecessarily time-consuming, for example, because the functionality of the curved corner surface 134 may not require that the curved corner surface 134 is obtained necessarily through grinding.

It is the object of the present invention to provide a cutting insert and a method of manufacture thereof, which significantly reduce or overcome the aforementioned disadvantages.

### SUMMARY OF THE INVENTION

In accordance with preferred embodiments of the current invention, there is a cutting insert having a top surface, a bottom surface and a peripheral surface extending therebetween, the peripheral surface comprising:

a first side surface and a second side surface, wherein at least one of the first and second side surfaces comprises a ground surface, and wherein at least one of the first and second side surfaces is substantially planar; and

a curved corner surface extending between the first side surface and the second side surface, the curved corner surface having a substantial curved unground portion immediately adjacent to the ground surface.

Also in accordance with preferred embodiments of the current invention, there is a method of manufacturing a cutting insert, the method including the steps of:

providing an insert blank comprising a blank top surface, a blank bottom surface and a blank peripheral surface extending therebetween, the blank peripheral surface including a curved blank corner surface extending between a blank first side surface and a blank second side surface; and

grinding at least one of the blank first and blank second side surfaces to form a cutting insert having a first side surface and a second side surface, at least one of which is substantially planar, without grinding a portion of the curved blank corner surface, so as to leave a curved corner surface having a substantial curved unground portion.

### BRIEF DESCRIPTION OF THE DRAWINGS

For a better understanding of the present invention and to show how the same may be carried out in practice, reference will now be made to the accompanying drawings, in which:

FIG. 1 is a bottom view of a cutting insert, showing four side surfaces after planar grinding of an insert blank, in accordance with embodiments of the prior art;

FIG. 2 is a bottom view of the cutting insert of FIG. 1, showing the four side and four corner surfaces after corner grinding of the insert blank, in accordance with embodiments of the prior art;

FIG. 3 is a bottom view of a cutting insert, showing four side and four corner surfaces after planar grinding of an insert blank, in accordance with some embodiments of the invention;

FIG. 4 is a side view of the cutting insert of FIG. 3, in accordance with some embodiments of the invention;

FIG. 5 is a perspective view of the cutting insert of FIGS. 3 and 4, in accordance with some embodiments of the invention;

FIG. 6 is a perspective view of a cutting insert, in accordance with other embodiments of the invention;

FIG. 7 is a perspective view of a cutting insert, in accordance with further embodiments of the invention; and

FIG. 8 is a bottom view of a corner of the cutting insert of FIG. 3, in accordance with some embodiments of the invention.

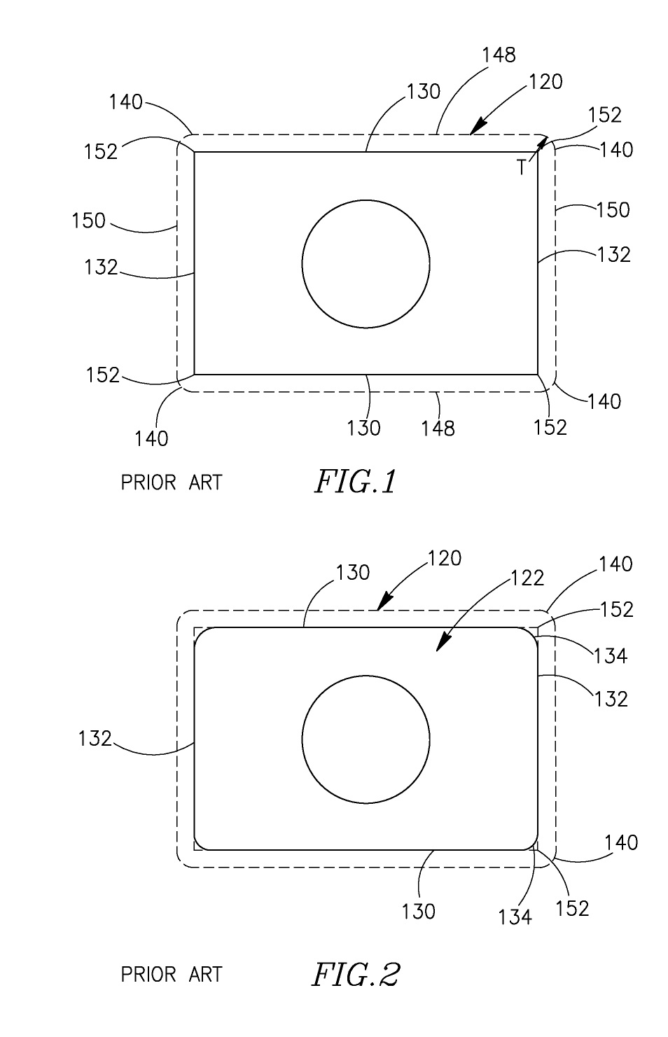

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention. In addition, elements shown in drawings herein may not be drawn to scale, or exaggerated, for demonstrative purposes only.

Although some drawings herein show a cutting insert having a specific shape, e.g., a generally rectangular shape, embodiments of the invention are not limited in this respect. Embodiments of the invention may include, or may refer to cutting inserts having other shapes. In particular, although drawings herein show a cutting insert of which one or more corner surfaces have a specific shape, e.g., a cylindrical segment shape, embodiments of the invention are not limited in this respect. Embodiments of the invention may include, or may refer to cutting inserts having one or more corner surfaces having other shapes. In addition, different embodiments of the invention may include cutting inserts having a different number of corner surfaces.

The term ‘blank’ as used herein, may be used to describe a cutting insert prior to undergoing grinding operations, and applies to surfaces which may, or may not be subsequently ground.

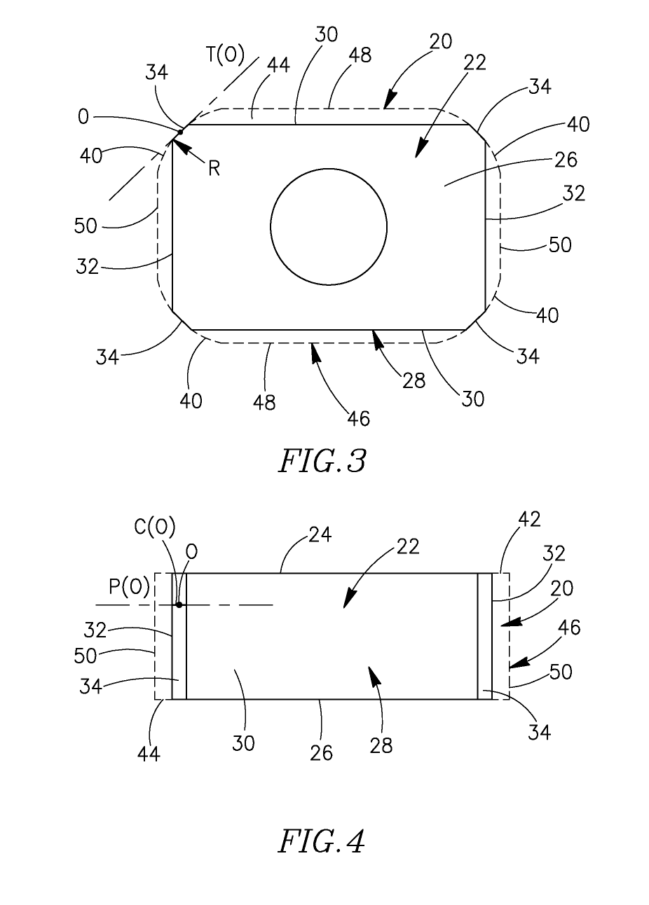

Reference is made to FIGS. 3-7, showing an insert blank 20 and a cutting insert 22 obtained therefrom, in accordance with a plurality of embodiments of the invention.

The invention includes the cutting insert 22 having a top surface 24, a bottom surface 26 and a peripheral surface 28 extending therebetween. The peripheral surface 28 includes a first side surface 30, a second side surface 32, and a corner surface 34 that extends at least partially between the first and second side surfaces 30 and 32. At least one of the first and second side surfaces 30 and 32 is substantially planar. The peripheral surface 28 may include additional one or more surfaces, for example, one or more additional corner surfaces 34.

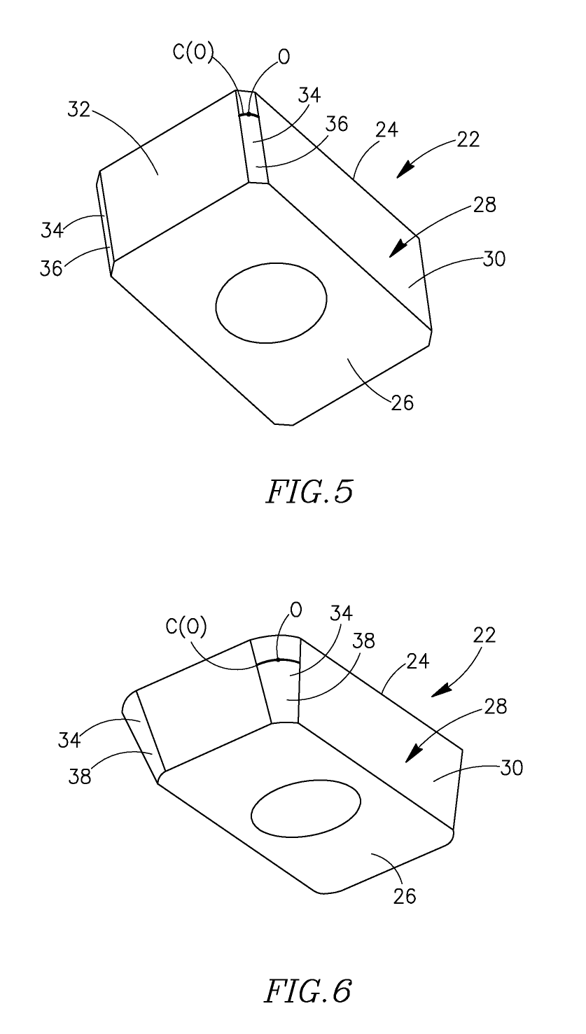

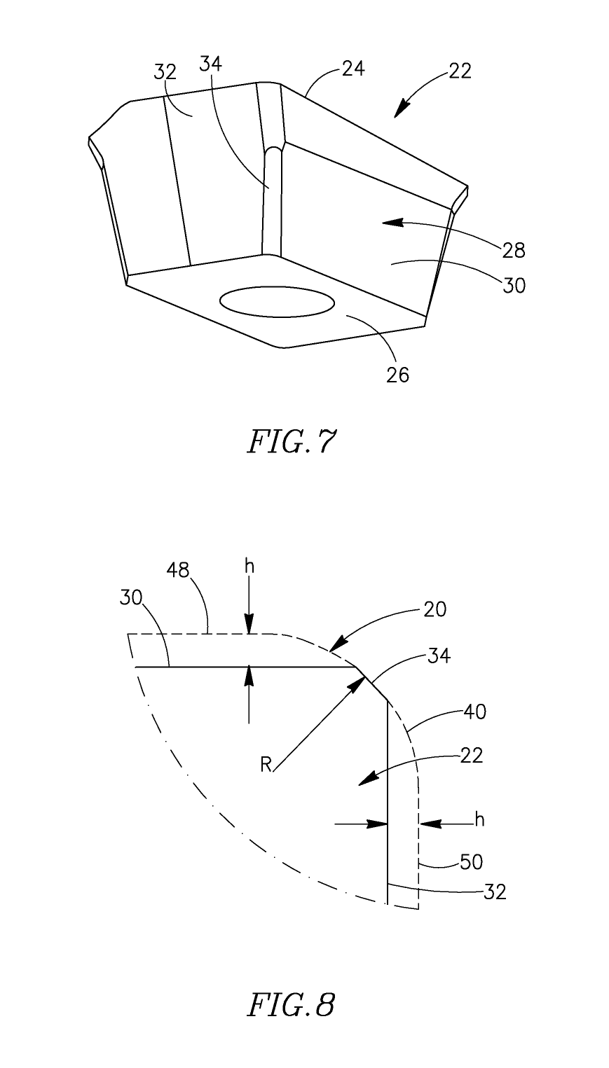

The first side surface 30, the second side surface 32 and/or the corner surface 34 may extend to the bottom surface 26 and/or to the top surface 24. In some embodiments, for example, the corner surface 34 extends to the bottom surface 26 and does not extend to the top surface 24, e.g. as shown in FIG. 7. In other embodiments the corner surface 34 extends to both the top surface 24 and the bottom surface 26, e.g., as shown in FIGS. 5 and 6.

The corner surface 34 may either be curved, or have a substantial portion that is curved. Henceforth, the term “curved corner surface” will refer to both of these. Each arbitrary point O on the curved corner surface 34 has an associated tangential plane T(O). A perpendicular plane P(O) is defined as the plane which passes through the point O, and is perpendicular to the tangential plane T(O) and to at least one of the first and second side surfaces 30 and 32 that is substantially planar. The term “radius of curvature” R at each arbitrary point O is defined as a radius of an osculating circle of a corner curve C(O) at the point O, wherein the corner curve C(O) is defined by the intersection of the perpendicular plane P(O) and the curved corner surface 34.

In some embodiments, the radius of curvature R at each arbitrary point O on the curved corner surface 34 is constant, for example, if the geometry of the cutting insert 22 is ‘negative’ and the curved corner surface 34 has a shape of a cylindrical segment 36, e.g., as shown in FIG. 5. In other embodiments the curved corner surface 34 may have a different radius of curvature R at different points O thereon. The curved corner surface 34 may be characterized by a varying radius of curvature R if, for example, the geometry of the cutting insert is ‘positive’, and the curved corner surface 34 has, for example, a shape of a frusto-conical segment 38, e.g., as shown in FIG. 6. In other embodiments, the curved corner surface 34 may assume other curved or partially curved shapes.

As described in detail below, the curved corner surface 34 is a residual portion of a curved blank corner surface 40 of the insert blank 20 which remains intact following grinding applied to obtain at least one of the first and second side surfaces 30 and 32. Accordingly, the curved corner surface 34 is devoid of grinding marks. This may be seen, for example, by observing the curved corner surface 34 with a magnifying lens. The curved corner surface 34 thus comprises a substantial curved unground portion that is immediately adjacent to a ground surface belonging to one, or each, of the first and second side surfaces 30, 32.

The invention includes a method of manufacturing the cutting insert 22. According to the invention, the method includes forming the insert blank 20, for example, using pressing and sintering or injection molding techniques. The insert blank 20 includes a blank top surface 42, a blank bottom surface 44, and a blank peripheral surface 46 extending therebetween. The blank peripheral surface 46 includes at least a blank first side surface 48, a blank second side surface 50, and the curved blank corner surface 40 at least partially extending therebetween.

In some embodiments the blank first side surface 48, the blank second side surface 50, and/or the curved blank corner surface 40 may each extend to the blank top surface 42 and/or to the blank bottom surface 44. As similarly described above, e.g., with respect to the curved corner surface 34 of the cutting insert 22, the curved blank corner surface 40 is characterized either by a constant or a varying radius of curvature R.

According to the invention, the method includes grinding at least one of the blank first side surface 48 and the blank second side surface 50, to respectively obtain therefrom the first and/or second side surfaces 30 and 32 of the cutting insert 22, without grinding a portion of the curved blank corner surface 40, so as to leave a curved corner surface 34 having a substantial curved unground portion. By virtue of grinding one or both of the first and second side surfaces 30, 32, the unground portion thus ends up being immediately adjacent to a ground surface belonging to one, or each, of the first and second side surfaces 30, 32. As described above, at least one of the first and second side surfaces 30 and 32 of the cutting insert 22 is substantially planar.

The curved blank corner surface 40, e.g., characterized by the radius of curvature R, is relatively large, for example, compared to other surfaces of the insert blank 20, and/or compared to a typical extent to which the blank first and/or second side surfaces 48 and 50 are ground. Accordingly, the grinding of the blank first and/or second side surfaces 48 and 50 may result in partial truncating of the curved blank corner surface 40. Nevertheless, e.g., due to the relatively large size of the curved blank corner surface 40, a significant residual portion thereof remains intact, and accordingly unmarked with grinding marks, after grinding is applied to the blank first and/or second side surfaces 48 and 50. The intact, residual portion of the curved blank corner surface 40 is the curved corner surface 34 of the cutting insert 22. A corner ratio Rc is defined as an area of the residual portion of the curved corner surface 34, divided by an area of the curved blank corner surface 40. In some embodiments, the corner ratio Rc assumes a value within the numerical range 0.2-0.4. In other embodiments, the corner ratio Rc assumes other positive values.

As an illustrative example, and as shown, for example, in FIG. 8, in some embodiments the radius of curvature R may receive, for example, a value of 1.5 millimeters. In this example, both the blank first side surface 48 and the blank second side surface 50 are ground to an extent h, which may assume a typical value, for example, of approximately 0.2 millimeters. Accordingly, in this example, planar grinding applied to the blank first and second side surfaces 48 and 50, to respectively form the first and second side surfaces 30 and 32 therefrom, results in that the intact residual portion or the curved corner surface 34 is approximately one third the area of the curved blank corner surface 40, i.e., the corner ratio Rc assumes a numerical value of approximately one third.

While the present invention has been described with reference to one or more specific embodiments, the description is intended to be illustrative as a whole and is not to be construed as limiting the invention to the embodiments shown. It is appreciated that various modifications may occur to those skilled in the art that, while not specifically shown herein, are nevertheless within the scope of the invention.

What is claimed is:

1. A cutting insert (22) having a top surface (24), a bottom surface (26) and a peripheral surface (28) extending therebetween, the peripheral surface (28) comprising:
a first side surface (30) and a second side surface (32), wherein at least one of the first and second side surfaces (30, 32) comprises a ground surface, and wherein at least one of the first and second side surfaces (30, 32) is substantially planar; and
a curved corner surface (34) extending between the first side surface (30) and the second side surface (32), the curved corner surface (34) having a substantial curved unground portion immediately adjacent to said ground surface.

2. The cutting insert (22) according to claim 1, wherein at least one of the first and second side surfaces (30, 32) is both planar and ground.

3. The cutting insert (22) according to claim 1, wherein the first side surface (30) and the second side surface (32) each comprise a ground surface and the substantial curved unground portion of the curved corner surface (34) is immediately adjacent to said each ground surface.

4. The cutting insert (22) according to claim 1, wherein the first side surface (30) and the second side surface (32) are both substantially planar.

5. The cutting insert (22) according to claim 1, wherein the unground portion of the curved corner surface (34) extends to at least one of the top and bottom surfaces (24, 26).

6. The cutting insert (22) according to claim 1, wherein the unground portion of the curved corner surface (34) extends to the top surface (24) and also to the bottom surface (26).

7. The cutting insert (22) according to claim 1, comprising two first side surfaces (30) and two second side surfaces (32).

8. The cutting insert (22) according to claim 1, wherein the unground portion of the curved corner surface (34) has a constant radius of curvature (R).

9. The cutting insert (22) according to claim 1, wherein the curved corner surface (34) is devoid of grinding marks.

10. A method of manufacturing a cutting insert (22), the method including the steps of:
providing an insert blank (20) comprising a blank top surface (42), a blank bottom surface (44) and a blank peripheral surface (46) extending therebetween, the blank peripheral surface (46) including a curved blank corner surface (40) extending between a blank first side surface (48) and a blank second side surface (50); and
grinding at least one of the blank first and blank second side surfaces (48, 50) to form a cutting insert (22) having a first side surface (30) and a second side surface (32), at least one of which is substantially planar, without grinding a portion of the curved blank corner surface (40), so as to leave a curved corner surface (34) having a substantial curved unground portion.

11. The method of manufacturing the cutting insert (22) according to claim 10, comprising providing a pressed and sintered, or an injection molded, insert blank (20).

12. The method of manufacturing the cutting insert (22) according to claim 10, comprising planarly grinding at least one of the first and second side surfaces (30, 32).

13. The method of manufacturing the cutting insert (22) according to claim 10, comprising grinding both the first side surface (30) and the second side surface (32) such that the substantial curved unground portion of the curved corner surface (34) is immediately adjacent to ground surfaces belonging to both the first side surface (30) and the second side surface (32).

14. The method of manufacturing the cutting insert (22) according to claim 10, comprising grinding both the first side surface (30) and the second side surface (32) such that both are substantially planar.

15. The method of manufacturing the cutting insert (22) according to claim 10, wherein the curved corner surface (34) has a constant radius of curvature (R).

16. The method of manufacturing the cutting insert (22) according to claim 10, wherein the curved corner surface (34) is devoid of grinding marks.

17. The method of manufacturing the cutting insert (22) according to claim 10, wherein said grinding results in a ratio of 0.2-0.4 between an area of the curved corner surface (34) and an area of the curved blank corner surface (40).

18. A method of manufacturing a cutting insert (22) having a top surface (24), a bottom surface (26) and a peripheral surface (28) extending therebetween, the peripheral surface (28), the cutting insert further comprising:
a first side surface (30) and a second side surface (32), wherein at least one of the first and second side surfaces (30, 32) comprises a ground surface, and wherein at least one of the first and second side surfaces (30, 32) is substantially planar; and
a curved corner surface (34) extending between the first side surface (30) and the second side surface (32), the curved corner surface (34) having a substantial curved unground portion immediately adjacent to said ground surface;
the method comprising:
providing an insert blank (20) comprising a blank top surface (42), a blank bottom surface (44) and a blank peripheral surface (46) extending therebetween, the blank peripheral surface (46) including a curved blank corner surface (40) extending between a blank first side surface (48) and a blank second side surface (50); and
grinding at least one of the blank first and blank second side surfaces (48, 50), without grinding a portion of the curved blank corner surface (40), so as to leave said a substantial curved unground portion immediately adjacent to said ground surface.
